(19) United States
(12) Patent Application Publication
(10) Pub. No.: US 2013/0054945 A1
(43) Pub. Date: Feb. 28, 2013

(54) ADAPTIVE SENSING FOR EARLY BOOTING OF DEVICES

(71) Applicants: Gordon George Free, Freeland, WA (US); Andrew William Lovitt, Redmond, WA (US)

(72) Inventors: Gordon George Free, Freeland, WA (US); Andrew William Lovitt, Redmond, WA (US)

(73) Assignee: MICROSOFT CORPORATION, Redmond, WA (US)

(21) Appl. No.: 13/216,651

(22) Filed: Aug. 24, 2011

(51) Int. Cl. G06F 9/00; G06F 1/32

(52) U.S. Cl. 713/2; 713/1

(57) ABSTRACT

Automatically performing configuration or activation activities on a device. A method includes collecting at least one of operational or environmental information about a device. The at least one of operational or environmental information about a device is used to determining an anticipated usage of the device. Based on the determined anticipated usage, at least one configuration or activation action is performed putting the device into a normal use state.

### BACKGROUND

### Background and Relevant Art

Computers and computing systems have affected nearly every aspect of modern living. Computers are generally involved in work, recreation, healthcare, transportation, entertainment, household management, etc.

Computing devices have morphed and changed over time. For example, some early computing devices were large electrical systems requiring large groups of engineers to maintain and service the system. To cause the computing device to perform a particular task, various physical and electronic switches were manually switched to complete circuits and to place the computing device in a particular state. In some cases, computing devices were constructed to perform a particular computing task with little configurability available for the computing device, such as an electronic calculator.

Later, computing systems became more configurable and/or had the ability to perform multiple different related or unrelated tasks. However, this came at the expense of loading an operating system onto the computing system and then running applications within the operating system environment. Loading the operating system required some boot-up time. To conserve power, a computing system would be turned off and a restart incurred a time cost while waiting for the system to boot-up again.

As computing systems have further advanced, the systems are able to be put to sleep, which keeps the operating system loaded in computer memory, with low power sustaining the memory, but shutting down many other power consuming portions of the system. The system can then be resumed without requiring a full boot-up, thus trading some power consumption for some time savings. This is especially useful for battery powered devices where there is a desire to conserve battery power to give longer operating times between battery charges.

Computing systems are ubiquitous. In particular, embedded systems may be used to control everything from door locks to cellular telephones, to automobile controls, to appliance controls, to media devices, etc. Additionally, mobile computing devices have become useful and popular, such as for example, tablet computers, music players, etc. It is desirable for users to access the functionality of these devices quickly, without long wait times. The term “instant on” has been used to describe desirable functionality.

However, while “instant on” is the terminology used to describe these types of devices, there is often some wait to be able to use the devices. Further, mobile and embedded devices are becoming more complicated and thus have potentially longer and longer boot-up and resume or wake times.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method practiced in a computing environment. The method includes acts for automatically performing configuration or activation activities on a device. The method includes collecting at least one of operational or environmental information about a device. The at least one of operational or environmental information about a device is used to determining an anticipated usage of the device. Based on the determined anticipated usage, at least one configuration or activation action is performed putting the device into a normal use state.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a block diagram of an adaptive system;

FIG. 2 illustrates a process flow at various stages of an adaptive system; and

FIG. 3 illustrates a method of performing configuration or activation activities.

### DETAILED DESCRIPTION

Some embodiments use sensors, to detect changes in an environment. Using this information with a decision engine, a device can selectively boot-up, wake, load programmatic components, or otherwise activate sections of a system (hardware and/or software) to provide the appearance of ‘always on’ functionality while conserving power.

In some embodiments, software and/or hardware are selectively activated based on previous usage data. Thus, an entire device may not be “brought-up” until the user interacts directly with the device in a manner which, based on historical and/or typical interactions, indicates that the user wishes to fully interact with the device. However environmental conditions, the user's indirect actions, historical data, chronological conditions, etc. can have an effect on the device causing the device to anticipate user interaction. Anticipation triggers can be adjusted based on ongoing learning regarding the interactions. Anticipation triggers cause the device and begin activation activities, such as booting-up, waking up, performing restore operations, loading software into memory, turning on hardware, etc. However these activation activities may not be a complete boot-up and/or may not be visible and/or otherwise discernable to the user. Thus when the user finally interacts with the device the device may take a significantly shorter amount of time to be ready for full user interaction. Alternatively, the device may be ready for partial interaction. For instance the system may know that a user uses the navigation engine in car first, always, and thus the system brings up that system first and loads the rest of the system in the background.

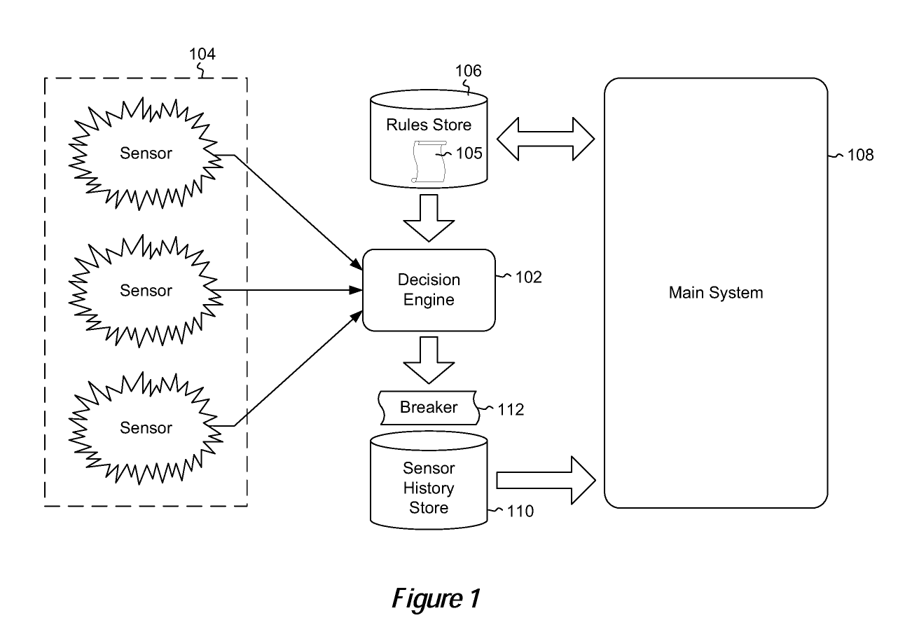

Referring now to FIG. 1 an example block diagram of one embodiment is illustrated. FIG. 1 illustrates logical connections for various components. As illustrated in FIG. 1, a decision engine 102 accepts as input sensor information from sensors 104. As will be discussed in more detail below, the sensors 104 can be one or more of a number of different sensor types. For example, the sensors may include, but are not limited to, one or more of the following: a clock, a timer, Wi-Fi hardware, a light sensor, a GPS, an accelerometer, a camera, a depth sensor (such as a infrared distance sensors or stereoscopic cameras) a temperature sensor, a switch, a pressure sensor, a spectrum analyzer, etc.

In some embodiments, sensors may be low power sensors. To facilitate the usage of the sensor data the device may perform simple or complex mathematical, logical, data structure, etc. manipulations or a combination of multiple simple or complex mathematical, logical, data structure, etc. manipulations using the sensor data as input.

As noted above, embodiments may include a decision engine 102 and a rules store 106. The decision engine 102 takes sensor input from the sensors 104 and applies rules 105 from the rules store 106 to the system. In some embodiments, the decision engine 102 applies rules 105 stored in a rule store 106 to determine when the main system 108 (or which parts of the main system 108) should be activated. The decision engine 102 can also access information regarding the history of the sensors 104 stored in a sensor history store 110 which can be used in calculations to determine actions. The main system 108 can consume the information in the sensor history store 110 and adjust the boot rules 105 stored in the rules store 106 appropriately.

The rules store 106 and/or the sensor history store 110 can include components that are independent of the system memory and storage. Alternatively or additionally, the rules store 106 and/or the sensor history store 110 can include components that are part of the system memory and storage.

The rules 105 in the rules store 106 may be generated in one or more of a number of different ways. For example, in some embodiments, rules are statically computed, such as for example by a system manufacturer. In an alternative or additional embodiment, rules may be automatically generated and/or learned. For example, embodiments may use artificial intelligence, decision trees, directed graphs, simple logic and/or other operations to generate, change, and/or remove rules from the rules store 106. In yet another alternative or additional embodiment, rules can be manually entered or configured by user input, where a device user makes decisions using a user interface which causes rules to be created, changed or removed.

In some embodiments, some or all of the rules 105 originate from the processor or set of processors and process or set of processes which is/are tasked applying the rules 105. In an alternative or additional embodiment, some or all of the rules 105 may originate from another processor. In some embodiments, rules 105 can be automatically generated in the cloud (i.e. a set of networked systems) and pushed to the device through specific or general update procedures. In some embodiments, the device may store the history of multiple interactions in a temporary store which can then be read by a rule generating procedure. This data may be filtered by signal collection code. The sensor history 110 can store a historical record from this or possibly previous boots which is then consumed by the rules generation engine to create or augment the rules store 105.

In some embodiments, some or all rules 105 can be static or non-changing. Alternatively or additionally, some or all rules 105 can be dynamic allowing for automatic adjustment or removal as time and experience trains the system. In some embodiments, the system can be completely or partially user configurable by a user being able to add, change or remove rules, or for the system to be disabled by a user by temporarily or permanently removing one or more rules 105 or the rules store 106 from the system.

In some embodiments, the system may store sensor information (e.g. sensor reading) associated with any activation process, whether from preemptive activation processes caused by a rules based activation or a user initiated activation process where a user is directly trying to initiate an activation process. This will allow the system to learn the scenarios for false-alarms and missed-hits more accurately. In particular, sensor information associated with an activation process, may include sensor readings occurring proximate or during an activation process. Further, while a rules based initiated activation process may involve some user interaction, the user interaction is typically incidental and not directly typically considered an initiating activity of a device. Such incidental interaction may include for example, coming proximate a device, incidentally touching or picking up a device, etc. In contrast user initiated activation process where a user is directly trying to initiate an activation process typically involves a user performing some activity that is generally known to cause activation activities, such as pressing a power button or other button, plugging in a device or otherwise supplying power to a device, etc.

Embodiments may include functionality whereby the system starts external devices or components based on the rules 105 or learned behaviors of the system. For instance a car infotainment system could, alternatively or in addition to booting the system, start the car in response to various rules 105 or learned behaviors. This could be used to start the car for the user based on an anticipation that the user is going to want to drive the care in the near future. Alternatively, the car may be started to recharge the battery of the car if a determination is made that the battery needs to be charged. This determination may include location information as well. For example, it may be inappropriate to start a vehicle in a closed garage or other space.

The system may include functionality to mutate the boot order for hardware, drivers, etc. for either the normal boot or the preemptive boot to take into consideration power, time, gas (car fuel), time of day, etc. This could mean, in some embodiments, in an automobile example, booting up the Bluetooth core early because it is known that the user always connects their phone to the car infotainment system or, in a home entertainment system example, bringing up the sound first because the TV user listens to the TV more before sitting down. The adjusted boot order may leave out major sections of the system from booting up, being powered, or being loaded if the system's rules 105 or learned behavior makes it unlikely that the user will use that portion of the system.

In some embodiments, functionality can be implemented using a separate low-power processor. In particular, the separate processor could be used to power the decision engine and/or other systems to cause activation activities to begin. Alternatively or additionally, the main CPU in a low-power state may be used for the decision engine and/or causing activation activities to begin. The decision engine 102 could be all or part of a separate chip, part of the OS, a hypervisor, etc. Still other options, though not specifically enumerated here, could be used within the scope of the embodiments described herein.

In some embodiments, functionality can be run over the operating system or instead of the operating system. When the system detects an appropriate event the system will power up/load/activate software or hardware based on the content of the rules 105 in the rules store 106. In some embodiments, this allows the main system 108 to retrieve sensor information once full system activation has actually occurred.

Embodiments may be implemented where devices use information available to the devices to select behaviors based on available information and/or sensor signals. This can reduce time spent waiting for a user to use a device and allow the perception of the device being ‘always-on’. However, in some embodiments the perception of being ‘always-on’ is a typical or on average perception given that learned models can be wrong. Thus, there may be situations when activation activities are not performed when it would be useful to perform them as a result of models being incomplete, erroneous sensor data, etc.

The output of the decision engine 102 may also pass through a ‘breaker’ 112, which may be implemented using electrical circuitry to physically prevent signals from being transmitted or software which can prevent data from being passed, which can prevent the system from performing activation activities based on the interaction. This may be implemented to ensure that the system does not come online when users are not in a position to use the system. This can be done, for example, to conserve battery. For example, in an automobile setting, if the device has been powered up multiple times without the engine coming online then the device can prevent itself from turning on again. In some embodiments, this prevention can be performed until the car is turned on and the device interacted with. Thus, the system will come up when it normally should, but the system will not try to boot up early.

In some embodiments, a device can be initialized without turning on one or more user perceptible interfaces. For example, in some embodiments, the screen may be prevented from being turned on until further user action is detected. Alternatively, sound portions of the device may be prevented from being turned on until further user interaction is detected.

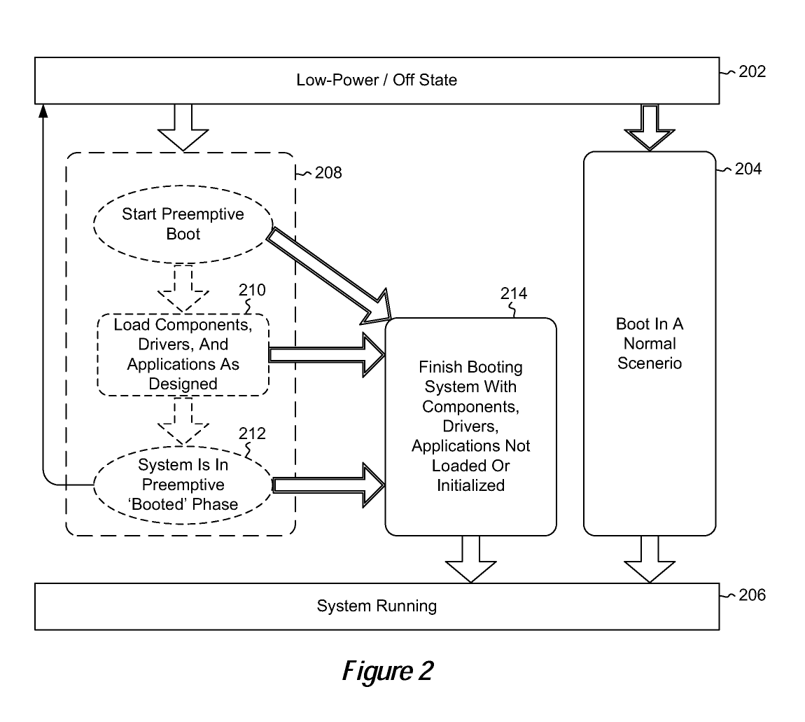

FIG. 2 shows the logical flow of the system from a scenario perspective. In FIG. 2, stages illustrated by dashed lines are considered preemptive boot stages and stages illustrated by solid lines are ‘normal’ boot mode code and scenarios. Arrows shown with double solid outlines represent an unambiguous start signal, such as depression of a power switch, placement of or tuning a key in an ignition, remote power button presses, etc.

FIG. 2 illustrates at 202 that the system starts in a low-power or ‘off state’. In this state the decision engine 102 from FIG. 1 is still active and collecting sensor information from the sensors 104. In this state the system can receive a ‘start-up’ command (button press, etc.) that it was not expecting, in which case the system would boot normally as illustrated at 204, until the system is running normally as illustrated at 206.

Alternatively, the system may detect an occurrence of a situation where the system anticipates the user interacting with the system the system will enter the pre-emptive boot phase as illustrated at 208. In this phase any number (or none) of the components, drivers, chips, applications, etc. can be booted (or otherwise started-up) as illustrated at 210. Once this is done the system will enter the ‘booted’ phase of the preemptive boot scenario as illustrated at 212. Then when a start-up command is received, the system will finish the boot-up and begin the system in the system running phase as illustrated at 206.

The preemptive boot phase can be interrupted at any time by a ‘start-up’ signal which will quickly transition to the finishing the boot sequence illustrated at 214 based on the partial boot already performed. Either in the booting or ‘finish preemptive booting phase’ and/or in the preemptive boot phase the sensor information is transferred and stored so the system can analyze the boot whether or not the boot was successful to update the rules 105 if the system is configured to update the rules 105. If the system is in a preemptive ‘booted’ phase for too long the system will return to the low-power state and store in the sensor history store 110 that the boot-up was a false-alarm.

Embodiments may include various features. For example, embodiments may include the ability to learn usage patterns for the device to build a model for turning on and off sections of the device or the entire device. Alternatively or additionally, embodiments may include the ability to use sensors (possibly low-power sensors or passive sensors) to adjust state of the embedded device. Alternatively or additionally, embodiments may include the ability to adjust the power/application state of the devices based on settings related to timing. Alternatively or additionally, embodiments may include the ability to boot up sections of the device but not the entire device due to signals from the sensors or time. Alternatively or additionally, embodiments may include the ability to change the boot order of the components and drivers based on rules 105 or learned behavior. Alternatively or additionally, embodiments may include the ability to turn on the entire device and start external devices or components. Alternatively or additionally, embodiments may include the ability to (possibly filtered) signal to a temporary store so the device knows what immediately preceded a power-on initiation by the user so the device can learn the rules 105 for power-on. Alternatively or additionally, embodiments may include the ability to monitor previous on/off state transitions to augment the learned patterns in ways to prevent battery drainage. Alternatively or additionally, embodiments may include the ability to supplied offline trained models and rules 105 to the engine. Alternatively or additionally, embodiments may include the ability to incorporate sensors, possibly disjoint, on a network possibly, and wirelessly possibly to the device for implementation. Alternatively or additionally, embodiments may include the ability for rules 105 to be pushed to the system by an update mechanism of time and the responsiveness of the device to power on commands is generally reduced.

The following now illustrates some example of some sensors that may be implemented in various embodiments. Some embodiments may include an acceleration or tilt sensor, such as an accelerometer. This can be used to detect movement of the device.

Some embodiments may include sensors configured to detect when a neighboring device is turned on or comes in proximity with the device. For example, Bluetooth or Wi-Fi radios could be used for this purpose for wireless detection. Alternatively, wired connection such as docking stations and/or other electrical connections could be used to detect proximity or devices being turned on.

Some embodiments may include sensors configured to detect light. For example, a photodiode may be used with supporting circuitry to detect the presence or absence of light or changes in lighting.

Some embodiments may include clock and/or timer sensors configured to detect absolute time, elapsed time, etc. For example, using a clock, a determination can be made that certain actions or events happen at a given time of day. Using a timer, a determination can be made that a given amount of time has elapsed between events.

Some embodiments may include sensors configured to detect and/or store current or historical navigation or GPS data. For example, a determination can be made as to where a device has been or a route that a device has traveled or where a device currently is located.

The following now illustrate a number of operational examples. Each is illustrated as an example, and while different examples and functionality may be used in concert, such concerted usage is not necessarily required by any embodiments of the invention.

One example is illustrated in an automotive environment. In this example, embodiments may detect that a cell phone is within range of a car. Embodiments may pair the cell phone to the car to recognize the cell phone. Alternatively or additionally, the car may be opened with an unlock command from a key chain. Alternatively or additionally, a camera in the car may detect that a user is sitting in the driver seat. This example illustrates an automotive entertainment system. In this example the user usually unlocks the car using a wand, key, or other device. Given that the car is usually locked when the user is not in the car, this information can be used to build a user model for the system. When the car becomes unlocked the system starts to boot up in anticipation of the user turning on the car soon. The system will boot up everything including non-visible peripherals (for instance a screen will not come on nor will the amplifier for the speakers come on but the internal Wi-Fi and such chips could possibly be enabled and booted though no connections will be made). When the user starts the car, the system is already booting and the start command from the CAN bus will allow a control board to enable the entire system (i.e. finish the entire boot scenario).

This system can also learn behaviors of the users, for instance, someone comes home every night and unloads their car by locking and unlocking their car. The car then learns this behavior and doesn't boot the system during this time. The system can also determine if the system has been booted multiple times without the car actually being started and in this case a control board will not cause a pre-boot to occur to save battery life.

This example is materially different than door-open or handle-up boot up scenarios as the system can incorporate more than just one sensor to build the model and make decisions. Additionally the entire system is not booted until the user active scenario is reached. For example, in an automobile scenario, this may be when the car is on which is a non-off position of the key. The system boots up in a non-complete way. In other words, the entire system is not booted up.

In some embodiments, a piece and/or the entire system may be activated in a way such that the piece and/or entire system is not interactable. Embodiments may be designed to begin booting up (or otherwise performing activation or configuration activities) such that activities which are ordinarily invisible to the user are performed. This boot-up may include wireless and connections to devices however this is not necessarily required.

In another scenario of the above automotive example, a user walks out to the car (e.g. to go to work) at different times in the morning. The car learns this but the car also knows the user always carries their phone with them when they leave for work. Thus the car would follow the procedure described above when the phone comes near the car in the morning.

Illustrating now another automotive example, the car knows the user has been to the grocery store most recently from the historical GPS data. Thus when the car is disabled the car will ensure the system does not perform a preemptive power-on for the next 20 minutes while the car is unloaded. In some embodiments, this could also be augmented by time of day (e.g. the user may only shop on the weekends) and time of year (e.g. in the summer and fall the user may run to soccer practice after shopping).

Illustrating yet another automotive example, the car is left unlocked over night and in the morning the dad puts the kids in the backseat which the onboard camera detects as an unexpected lighting change, or a change in a depth aware camera, and knows that when an object is placed in the back of the car the user is likely to drive the car somewhere and thus the system preemptively powers on. Alternatively or additionally, when it is determined that the backseat is occupied, embodiments may start booting the rear seat entertainment system.

Illustrating yet another automotive example, the user typically loads their car before they start the car in the mornings before work. So when the car notices the user putting materials in the car the car may preemptive start the car and boot the entire system since the car has learned the user will get into the car very quickly and drive.

The following now illustrates a mobile phone example. A mobile phone goes to sleep when the phone is left for a long period of time. However the phone knows when it is picked up (e.g. from a sensor such as an accelerometer). Thus when the phone is picked up, in one embodiment, the phone anticipates the power-on button press and will start initializing the system without turning on the screen. However, in an alternative or additional embodiment, the user also picks up his phone every morning and puts it in his pocket without turning on the phone. Thus the phone learns that in the morning the phone will not be turned on between 7:30 and 8:00 so the phone doesn't start to power up when picked up within that time. In yet a further alternative or additional embodiment, the phone further learns that the car keys will not be next to the phone in this situation, thus when there is no car key next to the phone the phone will not turn on the processor. The car keys may be detected, for example, using RFID, Bluetooth, other wireless communication functionality, camera functionality, etc.

In an alternative or additional mobile phone embodiment, a mobile operator has worked with a movie theater operator to make sure a phone is not turned on during the movie. Some embodiments may be implemented where the mobile operator will not turn on the device when the user is in a dark room where there are significant audio signals. This has the added benefit that in situations where there is a lot of noise there is likely no need for a phone. In these situations if the user needs to use their phone they can still push the power button, it will just take a while longer to power on due to the software and hardware not being preemptively booted.

In yet another alternative or addition mobile phone embodiment, a phone knows that the user rarely plays games (or other graphic intensive applications) nor does the user surf the web during normal work hours. However the user does check their email during the work day. So while the user is in the office (detected by sensors and/or timing information) the phone will adjust the boot order to boot the drivers/software/applications/hardware associated with this email checking to the earliest possible moments of booting so the email access is available before other operations. Then later in the evening the boot order can be adjusted for other scenarios when the usage is not as predictable to the system.

Another example embodiment relates to televisions. TVs are becoming smarter and smarter. As such the TV requires boot-up time which is unrelated to delays needed to warm up the actual screen. In this example the TV can detect when light comes into the room where it is. When this happens the system starts to boot up. Then when the user presses the power button the TV will automatically come to life. This TV can also learn that the user typically watches TV in the mornings and Saturday nights, thus during those times the TV can be turned on quickly due to this pre-boot.

Illustrating now another television example, the TV may know that the users do not watch TV in the morning. Thus if the lights are turned on in the room in the morning the TV will not boot-up preemptively.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

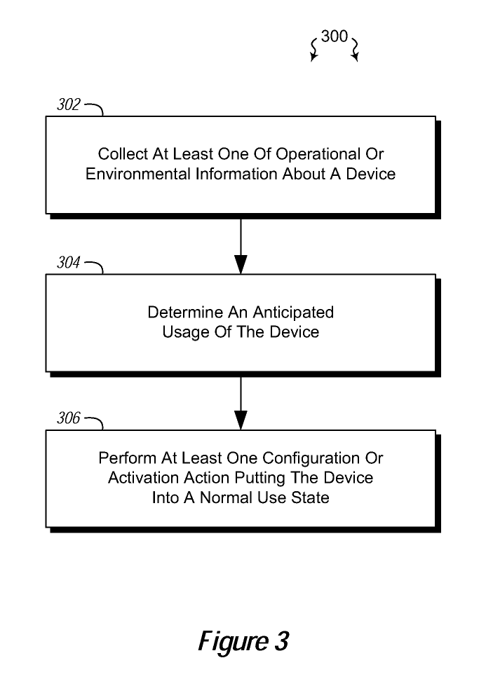

Referring now to FIG. 3, a method 300 is illustrated. The method 300 may be practiced in a computing environment and includes acts for automatically performing configuration or activation activities on a device. The method includes collecting at least one of operational or environmental information about a device (act 302). In some embodiments, collecting environmental information collecting sensor data. Such sensor data may be provided by one or more of a GPS, a light sensor, a proximity sensor, a heat sensor, an accelerometer, a blue-tooth radio, a spectrometer, wireless network hardware, wired network hardware, camera, depth camera, visible light camera, IR sensor, etc. Embodiments may be implemented where anything sent through the wireless network including wake on LAN commands can be sent from any suitable entity. For example, wireless commands may be sent by a television or automobile, (as illustrated in this disclosure) or other devices. As illustrated herein sensor data may additionally or alternatively include hardware indicating a power state. For example, hardware could indicate if a device (or if a part of a device) is on or off.

In some embodiments, collecting environmental information may include collecting indirect environmental information. For example, in a home environment, a sensor may detect when a television is turned off and when a car is turned on. A system may be able to determine that in the morning, when the television is turned off, the car will be turned on a short time later. This can be used to create a rule which causes car systems to begin activation activities, like booting-up, when a television system turns off in the morning. Thus, sensor data from one system may affect responses of a different system.

In some embodiments, collecting operational information includes collecting information such as how long the device has been active, time of day, what actions the device has been performing or associated with, one or more activation states of the device, a state of the devices hardware.

The method 300 further includes using the at least one of operational or environmental information about a device, determining an anticipated usage of the device (act 304). In some embodiments, as illustrated above, determining an anticipated usage of the device includes applying rules. The rules may be determined or augmented, at least in part, by the operational or environmental information about a device. For example, as illustrated above, certain sensor readings may allow for rules to be created. Various examples are illustrated above. For example detection of shutting off of the television combined with subsequent starting of the car, if done a consistent number of times, may result in a rule that causes the car to be automatically booted-up when the television is turned off.

In some embodiments, determining an anticipated usage of the device includes applying rules. The rules may be determined or augmented, at least in part, by user interaction. For example, a user could manually specify rules or adjust pre-defined or automatically defined rules. This may be done in one example, by the user using a user interface that displays a textual representation of the rules and allowing the user to modify values of the textual representation. Alternatively or additionally, a user could add new rules or completely remove some rules. Embodiments may be implemented where rules may also be limited or augmented by a manufacturer, through firmware or software updates, etc. For instance a particular automobile manufacturer may never want the car to preemptively boot based on GPS data. This could be incorporated into the rules store 106 as well

Embodiments may be practiced where determining an anticipated usage of the device is based on rules generated at the device. Environmental and/or operation data could be used at the device. This data could be used to formulate rules, which could then be used by the device to make activation or configuration activity decisions. In some such embodiments, determining an anticipated usage of the device is performed using a decision engine on a main CPU of the device. In alternative or additional embodiments, determining an anticipated usage of the device is performed using a decision engine on a sub chip of the device.

Embodiments may be practiced where determining an anticipated usage of the device is based on rules generated on a server external to the device. For example, a home automation system may be able to communicate to one or more devices. Environmental and/or operation data could be fed into the home automation server. This data could be used to formulate rules, which could then either be downloaded back to the device and stored or accessed by the device using a connection to external storage with the rules.

In an alternative or additional embodiment, determining an anticipated usage of the device may be based on rules generated in a cloud external to the device. A set of connected systems forming a computing cloud may be used to provide processing power to process environmental, operational and/or sensor data to formulae rules.

The method 300 further includes based on the determined anticipated usage, performing at least one configuration or activation action putting the device into a normal use state (act 306). The normal use state may be, for example, a non-failure state. The normal use state may be an optimization over a default state. While a normal use state could be a state where a device is brought up to full functionality, in other embodiments, the normal use may be a device that is partially booted or brought up and simply needs other actions to occur for be fully booted or brought up. For example, a normal use state does not require that all drivers and hardware are booted or brought up. In some embodiments, the activation activity may include booting the device. Alternatively or additionally, the activation activity may include booting the device and preventing a display on the device from activating. In some embodiments, the activation activity may include putting the device in to a low power condition. This may be performed, for example by loading a minimal or subset of drivers, powering or booting a minimal or subset of chips, and/or loading and running a minimal or subset of code. For example, the activation activity may include activating a set of control chips. Alternatively or additionally, the activation activity may include determining to not boot, or perform other types of start-up on the device. Alternatively or additionally, the activation activity may include lowering the power usage state of the device. For example, lowering the power usage state may include shutting the device down, putting the device into a low power mode, shutting down various hardware on the device, such as various chips on the device, etc.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of automatically performing configuration or activation activities on a device, the method comprising:
collecting at least one of operational or environmental information about a device;
using the at least one of operational or environmental information about a device, determining an anticipated usage of the device; and
based on the determined anticipated usage, performing at least one configuration or activation action putting the device into a normal use state.

2. The method of claim 1, wherein the normal use state is a non-failure state.

3. The method of claim 1, wherein the normal use state is an optimization over a default state.

4. The method of claim 1, wherein determining an anticipated usage of the device comprises applying rules, the rules being determined or augmented, at least in part, by the at least one of operational or environmental information about a device.

5. The method of claim 1, wherein determining an anticipated usage of the device comprises applying rules, the rules being determined or augmented, at least in part, by user interaction.

6. The method of claim 1, wherein the activation activity comprises booting the device.

7. The method of claim 1, wherein the activation activity comprises booting the device and preventing a display on the device from activating.

8. The method of claim 1, wherein the activation activity comprises putting the device in to a low power condition with a minimal set of drivers being loaded.

9. The method of claim 1, wherein the activation activity comprises activating a set of control chips.

10. The method of claim 1, wherein the activation activity comprises determining to not boot the device.

11. The method of claim 1, wherein the activation activity comprises lowering the power usage state of the device.

12. The method of claim 11, wherein lowering the power usage state of the device comprises shutting the device down.

13. The method of claim 1, wherein collecting environmental information comprises collecting sensor data.

14. The method of claim 13, wherein the sensor data is provided by at least one of a GPS, a light sensor, a proximity sensor, a heat sensor, an accelerometer, a blue-tooth radio, a spectrometer, wireless network hardware, wired network hardware, a camera, a switch, or hardware indicating power state of a device.

15. The method of claim 1, wherein collecting operational information comprises collecting at least one of information on how long the device has been active, time of day, what actions the device has been performing or associated with, one or more activation states of the device, a state of the devices hardware.

16. The method of claim 1, wherein determining an anticipated usage of the device is based on rules generated on a server external to the device.

17. The method of claim 1, wherein determining an anticipated usage of the device is based on rules generated in a cloud external to the device.

18. In a computing environment, a physical computer readable storage media method comprising computer executable instructions that when executed by one or more processors cause one or more processors to perform the following:
receive at least one of operational or environmental information about a device;
using the at least one of operational or environmental information about a device, determining an anticipated usage of the device; and
based on the determined anticipated usage, performing an activation action initializing the device.

19. The computer readable storage medium of claim 18, wherein initializing the device is done without turning on at least one user perceptible interface.

20. A system for automatically performing configuration or activation activities of a device, the system comprising:
one or more sensors;
a decision engine coupled to the one or more sensors, wherein the decision engine is configured to analyze at least one of operational or environmental information about a device from the one or more sensors;
a rules store coupled to the decision engine, wherein the rules store comprises rules useful by the decision engine to determine an anticipated usage of the device based at least in part on the at least one of operational or environmental information about a device; and
wherein the decision engine is configured to performing an activation action putting the device into a normal use state, but preventing initialization of at least one user perceptible interface until further user interaction is detected.
